(19) United States
(12) Patent Application Publication
(10) Pub. No.: US 2025/0378996 A1
(43) Pub. Date: Dec. 11, 2025

(54) MULTILAYER CERAMIC ELECTRONIC COMPONENT AND METHOD OF MANUFACTURING THE SAME

(71) Applicant: TAIYO YUDEN CO., LTD., Tokyo (JP)

(72) Inventors: Yusuke KOWASE, Tokyo (JP); Youichi MIZUNO, Tokyo (JP); Takashi SASAKI, Tokyo (JP); Hidetoshi MASUDA, Tokyo (JP)

(73) Assignee: TAIYO YUDEN CO., LTD., Tokyo (JP)

(21) Appl. No.: 19/312,788

(22) Filed: Aug. 28, 2025

Related U.S. Application Data
(63) Continuation of application No. PCT/JP2024/002789, filed on Jan. 30, 2024.

(30) Foreign Application Priority Data
Mar. 6, 2023 (JP) 2023-033848

(51) Int. Cl. H01G 4/232; H01G 4/30

(52) U.S. Cl. CPC H01G 4/2325; H01G 4/30

(57) ABSTRACT

A multilayer ceramic electronic component includes a ceramic element in which dielectric layers and internal electrodes are alternately laminated along a first axis direction, and a pair of external electrodes provided at end portions of the ceramic element in a third axis direction so as to be electrically connected to the internal electrodes led out to a different end surface of the ceramic element in the third axis direction. Each of the pair of external electrodes includes a first region and a second region in this order from the ceramic element. An average crystal grain size of crystal grains forming the first region is smaller than an average crystal grain size of crystal grains forming the second region.

### CROSS-REFERENCE TO RELATED APPLICATION

This application is based upon and claims the benefit of priority of the prior International Patent Application No. PCT/JP2024/002789, filed on Jan. 30, 2024, which claims the benefits of priorities of Japanese Patent Application No. 2023-033848 filed on Mar. 6, 2023, the entire contents of which are incorporated herein by reference.

### FIELD

A certain aspect of the present invention relates to a multilayer ceramic electronic component and a method of manufacturing the same.

### BACKGROUND

A multilayer ceramic capacitor, which is one of multilayer ceramic electronic components, includes a ceramic element in which a plurality of dielectric layers and a plurality of internal electrodes are alternately laminated, and a pair of external electrodes (terminal electrodes) formed on a surface of the multilayer body so as to be electrically connected to the internal electrodes led out to a surface of the multilayer body. Various structures of the external electrode have been proposed, and for example, a structure including a first electrode layer and a second electrode layer in this order from the ceramic element side is known (for example, see Japanese Unexamined Patent Application Publication No. 2012-9556).

### SUMMARY OF THE INVENTION

(1) According to an aspect of the present disclosure, there is provided a multilayer ceramic electronic component including: a ceramic element having dielectric layers and internal electrodes alternately laminated in a first axis direction, a pair of main surfaces facing each other along the first axis direction, a pair of side surfaces facing each other in a second axis direction orthogonal to the first axis direction, and a pair of end surfaces facing each other in a third axis direction orthogonal to the first axis direction and the second axis direction; and an external electrode provided at an end portion of the ceramic element in the third axis direction so as to be electrically connected to the internal electrode led out to a different end surface of the ceramic element in the third axis direction, wherein the external electrode includes a first region and a second region in this order from the ceramic element, and an average crystal grain size of crystal grains forming the first region is smaller than an average crystal grain size of crystal grains forming the second region.
(2) In the multilayer ceramic electronic component according to the above (1), the external electrode may include the first region in contact with the ceramic element and the second region in contact with the first region.
(3) In the multilayer ceramic electronic component according to the above (1), the average crystal grain size of crystal grains forming the first region may be 0.9 μm or more and 1.5 μm or less.
(4) In the multilayer ceramic electronic component according to the above (1), the average crystal grain size of crystal grains forming the second region may be 1.3 μm or more and 1.9 μm or less.
(5) In the multilayer ceramic electronic component according to the above (1), a main component of the first region and the second region may be Cu.
(6) In the multilayer ceramic electronic component according to the above (1), the first region may contain Ni as a main component and the second region may contain Cu as a main component.
(7) In the multilayer ceramic electronic component according to the above (1), the first region may have a thickness of 5 μm or more and 70 μm or less.
(8) In the multilayer ceramic electronic component according to the above (1), the second region may have a thickness of 5 μm or more and 70 μm or less.
(9) In the multilayer ceramic electronic component according to the above (1), the multilayer ceramic electronic component may further include a plating layer provided outside the second region.
(10) In the multilayer ceramic electronic component according to the above (1), a base layer of the external electrode may include a third region between the first region and the second region, and an average crystal grain size of crystal grains forming the third region may be between the average crystal grain size of crystal grains forming the first region and the average crystal grain size of crystal grains forming the second region.
(11) According to another aspect of the present disclosure, there is provided a method of manufacturing a multilayer ceramic electronic component, including: laminating ceramic sheets on which internal electrode patterns forming internal electrodes are formed in a first axis direction and pressure-bonding the ceramic sheets to obtain a multilayer sheet; cutting and firing the multilayer sheet to obtain a ceramic element in which dielectric layers and internal electrodes are alternately laminated along the first axis direction, the ceramic element having a pair of main surfaces facing each other along the first axis direction, a pair of side surfaces facing each other in a second axis direction orthogonal to the first axis direction, and a pair of end surfaces facing each other in a third axis direction orthogonal to the first axis direction and the second axis direction; disposing a first conductor paste for forming a first region having conductivity in a region including the end surfaces at both end portions of the ceramic element in the third axis direction; disposing a second conductive paste having an average crystal grain size larger than an average crystal grain size of the first conductive paste so as to overlap the first conductive paste, the second conductive paste being for forming a second region overlapping the first region; and sintering the first conductor paste and the second conductor paste.

### BRIEF DESCRIPTION OF THE DRAWINGS

FIG. 1 is a perspective view of a multilayer ceramic capacitor according to an embodiment.

FIG. 2A is a cross-sectional view taken along line A-A in FIG. 1, and FIG. 2B is a cross-sectional view taken along line B-B in FIG. 1.

FIG. 3 is an enlarged cross-sectional view of the periphery of an external electrode.

FIG. 4 is a cross-sectional view illustrating a state in which the multilayer ceramic capacitor according to the embodiment is mounted on a substrate.

FIG. 5 is a flowchart illustrating an example of a method for manufacturing the multilayer ceramic capacitor.

FIG. 6 is a perspective view illustrating a part of a step included in the method of manufacturing a multilayer ceramic capacitor according to the embodiment.

FIG. 7 is a perspective view illustrating a part of a step included in the method of manufacturing the multilayer ceramic capacitor according to the embodiment.

FIGS. 8A and 8B are perspective views illustrating a part of a step included in the method for manufacturing the multilayer ceramic capacitor according to the embodiment.

FIGS. 9A and 9B are explanatory views of variations.

FIG. 10 is a cross-sectional view illustrating a state in which a third region is formed between a first region and a second region.

### DETAILED DESCRIPTION

In the meantime, the multilayer ceramic electronic component is required to ensure moisture resistance in the dielectric layer. After the multilayer ceramic electronic component is mounted on a substrate, cracks might occur in the multilayer ceramic capacitor due to, for example, stress caused by deflection of the substrate, repeated stress caused by heat cycles, or the like. Therefore, the multilayer ceramic electronic component is required to have strength capable of withstanding these stresses.

A technique disclosed in Japanese Unexamined Patent Application Publication No. 2012-9556 has room for improvement in terms of improving the quality reliability of the multilayer ceramic electronic component.

An object of the present disclosure is to provide a multilayer ceramic electronic component with improved quality reliability.

Hereinafter, a multilayer ceramic capacitor 1 according to an embodiment of the present disclosure will be described with reference to the accompanying drawings. In the drawings, the dimensions, ratios, and the like of the respective parts may not be illustrated so as to completely match the actual ones. For convenience of drawing, details may be omitted or components themselves may be omitted depending on the drawings. In the drawings, an X-axis, a Y-axis, and a Z-axis orthogonal to each other are illustrated as appropriate. In the following description, a Z-axis direction corresponds to a first axis direction, and a Y-axis direction corresponds to a second axis direction. An X-axis direction corresponds to a third axis direction.

### Embodiment

### [Structure of Multilayer Ceramic Capacitor]

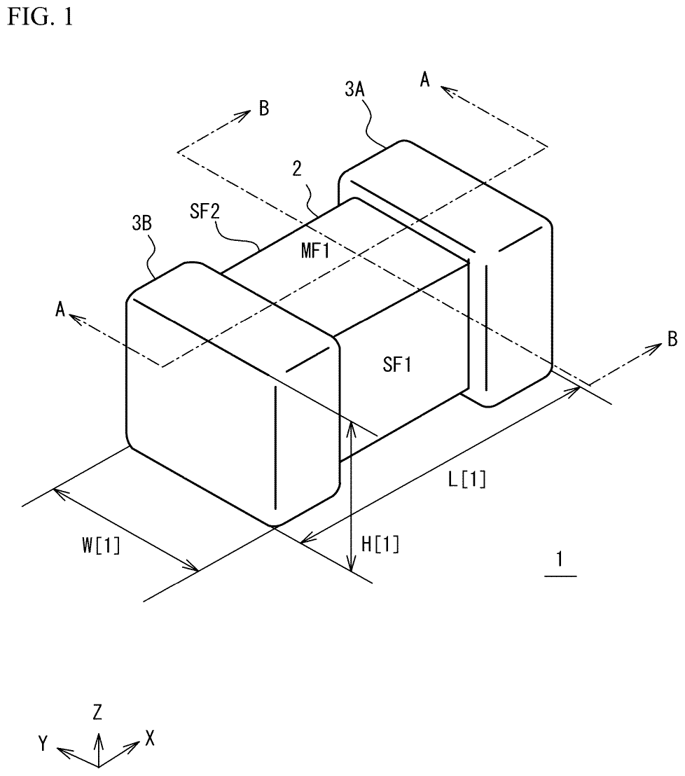

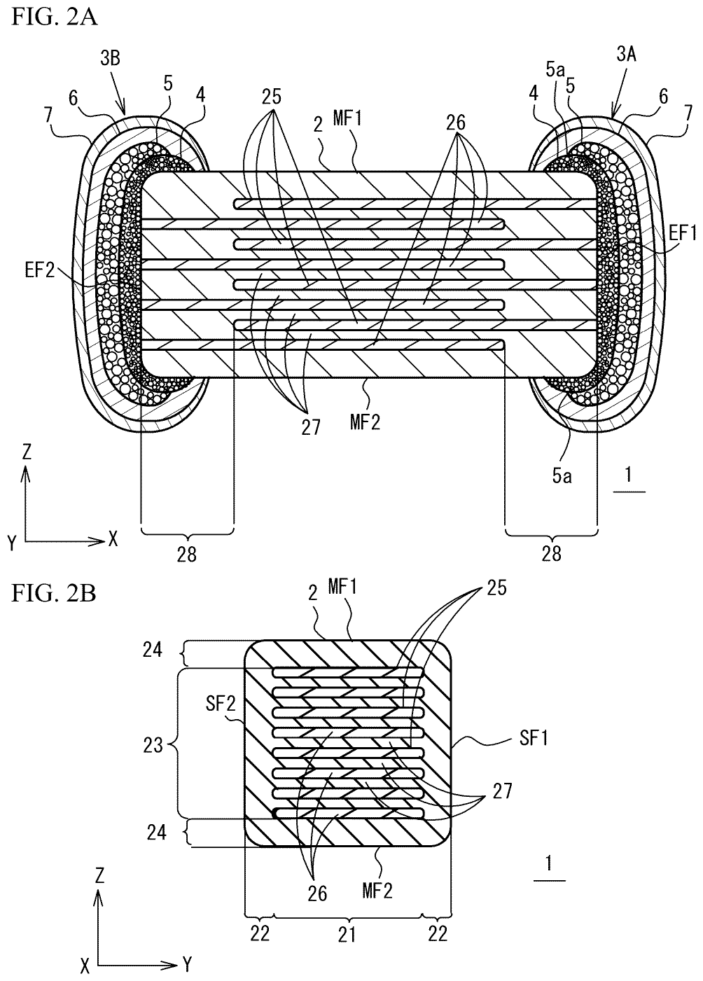

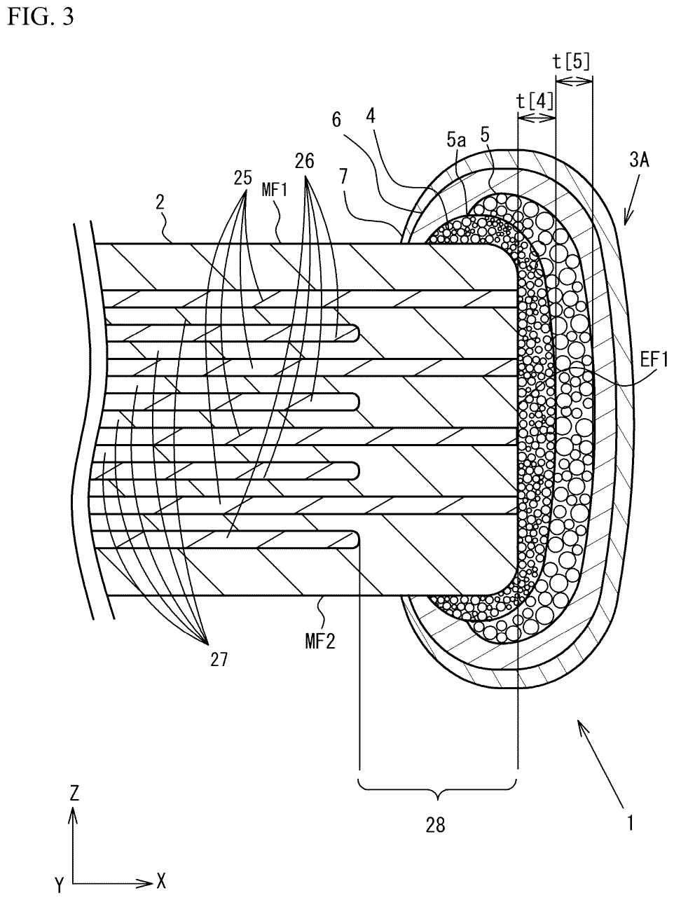

First, the multilayer ceramic capacitor (MLCC) 1 according to the embodiment will be described with reference to FIGS. 1 to 3. FIG. 1 is a perspective view of the multilayer ceramic capacitor 1. FIG. 2A is a cross-sectional view taken along line A-A in FIG. 1. FIG. 2B is a cross-sectional view taken along line B-B in FIG. 1. FIG. 3 is an enlarged view of the periphery of a first external electrode 3A. In the multilayer ceramic capacitor 1, the X-axis direction is the length direction, the Y-axis direction is the width direction, and the Z-axis direction is the height direction. Each cross-sectional view is schematically drawn in order to clearly illustrate the state of each cross-section. The multilayer ceramic capacitor of the present embodiment includes the first external electrode 3A and a second external electrode 3B, as will be described in detail later. The first external electrode 3A and the second external electrode 3B include a first region 4 and a second region 5 as conductive base layers, respectively. In each of the drawings, metal grains forming the first region 4 and the second region 5 are illustrated in a circular shape, but this does not represent the actual shape of the grains. The sizes of the circles illustrated in the drawings do not accurately represent the actual ratio of the grain diameters of the metal grains contained in the first region 4 and the second region 5, but schematically illustrate the magnitude relationship between the grain diameter of the metal grains contained in the first region 4 and the grain diameter of the metal grains contained in the second region 5.

The multilayer ceramic capacitor 1 includes a ceramic element 2, the first external electrode 3A provided at one end of the multilayer ceramic capacitor 1 in the length direction, and the second external electrode 3B provided at the other end of the multilayer ceramic capacitor 1.

The ceramic element 2 is formed as a hexahedron having a first main surface MF1 and a second main surface MF2 (referring to FIG. 2A) orthogonal to the Z-axis, a first end surface EF1 and a second end surface EF2 (referring to FIG. 2A) orthogonal to the X-axis, and a first side surface SF1 and a second side surface SF2 (referring to FIG. 2B) orthogonal to the Y-axis. The “hexahedron” may be substantially a hexahedron, and for example, ridges connecting the surfaces of the ceramic element 2 may be rounded.

The first main surface MF1, the second main surface MF2, the first end surface EF1, the second end surface EF2, the first side surface SF1, and the second side surface SF2 of the ceramic element 2 are all formed as flat surfaces. The flat surface according to the present embodiment may not be strictly a plane as long as it is a surface recognized as flat when viewed as a whole, and includes, for example, a surface having a minute uneven shape of the surface, a gently curved shape existing in a predetermined range, or the like.

The ceramic element 2 includes a multilayer portion 21 and a pair of side margins 22. The multilayer portion 21 includes a capacitance forming portion 23 and a pair of cover layers 24. The capacitance forming portion 23 includes a plurality of first internal electrodes 25 and a plurality of second internal electrodes 26 that are alternately laminated with a plurality of dielectric layers 27 along the Z-axis direction. In the present embodiment, the first internal electrode 25, the second internal electrode 26, and the dielectric layer 27 are each configured in a sheet shape extending along the X-Y plane. The multilayer number of the first internal electrodes 25 and the multilayer number of the second internal electrodes 26 in each drawing does not represent the actual number of the multilayers.

The first internal electrode 25 and the second internal electrode 26 are alternately arranged along the Z-axis direction (height direction) so as to face each other through the dielectric layer 27 in the Z-axis direction. The first internal electrode 25 and the second internal electrode 26 face each other in the Z-axis direction in an opposing region at the center in the X-axis direction and the Y-axis direction. The first internal electrodes 25 are led out from the opposing region to the first end surface EF1 through an end margin 28 and connected to the first external electrode 3A. The second internal electrodes 26 are led out from the opposing region to the second end surface EF2 through the end margin 28 and connected to the second external electrode 3B.

The material of the first internal electrode 25 and the second internal electrode 26 can be selected from metals such as Cu (copper), Fe (iron), Zn (zinc), Al (aluminum), Sn (tin), Ni (nickel), Ti (titanium), Ag (silver), Au (gold), Pt (platinum), Pd (palladium), Ta (tantalum), or W (tungsten), and may be an alloy containing these metals.

In the multilayer portion 21, a dielectric ceramic having a high dielectric constant is used in order to increase the capacitance of each dielectric layer 27 between the first internal electrode 25 and the second internal electrode 26. Examples of the dielectric ceramics having a high dielectric constant include materials having a perovskite structure containing barium (Ba) and titanium (Ti), typified by barium titanate (BaTiO₃).

The dielectric ceramics may be a composition system such as strontium titanate (SrTiO₃), calcium titanate (CaTiO₃), magnesium titanate (MgTiO₃), calcium zirconate (CaZrO₃), calcium zirconate titanate (Ca (Zr, Ti) O₃), barium calcium zirconate titanate ((Ba, Ca) (Zr, Ti) O₃), barium zirconate (BaZrO₃), and titanium oxide (TiO₂).

The pair of cover layers 24 covers the capacitance forming portion 23 from both sides in the Z-axis direction as a laminating direction. The cover layer 24 may also be referred to as a protective layer in the height direction. The cover layer 24 is formed of, for example, a multilayer body having ceramic sheets extending along the X-Y plane. The dielectric ceramics constituting the cover layer 24 preferably has the same main composition as the dielectric layer 27 from the viewpoint of suppressing internal stress and the like.

The pair of side margins 22 are formed along the Z-axis direction and cover the multilayer portion 21 from the Y-axis direction. The side margin 22 may be referred to as a protective layer in the width direction. The side margin 22 is formed on a surface of the multilayer portion 21 orthogonal to the Y-axis direction. The dielectric ceramics constituting the side margins 22 preferably has the same main composition as the dielectric layers 27 from the viewpoint of reducing internal stress and the like.

The multilayer ceramic capacitor 1 includes the first external electrode 3A provided at one end of the multilayer ceramic capacitor 1 in the length direction (X-axis direction) and the second external electrode 3B provided at the other end of the multilayer ceramic capacitor 1.

Next, the first external electrode 3A and the second external electrode 3B will be described. Since the configurations of the first external electrode 3A and the second external electrode 3B are substantially the same, the first external electrode 3A will be described below, and detailed description of the second external electrode 3B will be omitted. Referring to FIG. 3, the first external electrode 3A include the first region 4 and the second region 5 as base layers, and a first plating layer 6 and a second plating layer 7 as plating layers, in this order from the ceramic element 2.

The first external electrode 3A covers the first end surface EF1 and extend to four surfaces located around the first end surface EF1. That is, the first external electrode 3A extends to the pair of the first main surface MF1 and the second main surface MF2 as illustrated in FIG. 2A and FIG. 3. Although not illustrated, the first external electrode 3A extends to the pair of the first side surface SF1 and the second side surface SF2 (see FIG. 2B).

The first region 4 is provided so as to be in contact with the end surface EF1 of the ceramic element 2. The second region 5 is provided so as to be in contact with and overlap the first region 4. That is, the first region 4 and the second region 5 are formed in the first external electrode 3A in this order from the ceramic element 2, and the first region 4 is a lower layer and the second region 5 is an upper layer. In the present embodiment, the first region 4 is provided so as to be in contact with the first main surface MF1 and the second main surface MF2 of the ceramic element 2, but an end portion 5a the second region 5 is located on the first region 4 and does not reach the first main surface MF1 and the second main surface MF2. Although not illustrated, the first region 4 is provided so as to be in contact with the first side surface SF1 and the second side surface SF2, and the end portion 5a of the second region 5 is located on the first region 4 and does not reach the first side surface SF1 and the second side surface SF2. With the structure in which the end portion 5a of the second region 5 is located on the first region 4 without being in contact with the ceramic element 2, it is possible to reduce concentration of stresses on the ceramic element 2 at the end portions of the external electrodes.

Both the first region 4 and the second region 5 are conductive layers containing Cu (copper) as a main component, but the average crystal grain size is different between the first region 4 and the second region 5. Specifically, the average crystal grain size of Cu forming the first region 4 is smaller than the average crystal grain size of Cu forming the second region 5. The average crystal grain size of Cu forming the first region 4 in the present embodiment is, for example, 0.9 μm or more and 1.5 μm or less. In contrast, the average crystal grain size of Cu forming the second region 5 is, for example, 1.3 μm or more and 1.9 μm or less.

In this manner, the first region 4 having a small average crystal grain size is disposed on the inner side, and the second region 5 having a large average crystal grain size is disposed on the outer side, so that the moisture resistance and the crack resistance of the multilayer ceramic capacitor 1 can be improved. In order to improve the moisture resistance of the multilayer ceramic capacitor 1, it is important to suppress the entry of moisture into the ceramic element 2. In the multilayer ceramic capacitor 1 according to the present embodiment, the first region 4 having a small average grain size is disposed so as to be in contact with and cover the end portion of the ceramic element 2 including the end surface EF1, and thus, the entry of moisture into the ceramic element 2 is effectively suppressed, and the moisture resistance is improved. In the multilayer ceramic capacitor 1 according to the present embodiment, the second region 5 having a large average crystal grain size is disposed on the outer side, and thus stress from solder during solder mounting is relaxed, and crack resistance is improved. In a case where the strength of a metal material having a large average crystal grain size is compared with the strength of a metal material having a small average crystal grain size, the yield strength of the metal material having a large average crystal grain size is generally lower. In the present embodiment, by disposing the second region 5 having a low yield strength outside the external electrode in this manner, the stress applied to the external electrode from the solder after solder mounting is able to be effectively reduced, and thus the crack resistance of the multilayer ceramic capacitor 1 after solder mounting is able to be improved.

A thickness t[4] of the first region 4 is 5 μm or more and 70 μm or less. Here, the thickness t[4] is a length along the X-axis direction from the boundary between the first region 4 and the end surface EF1 to the first region 4 and the second region 5. The thickness t[4] in the present embodiment may be obtained by, for example, drawing ten straight lines in the X-axis direction at ten positions obtained by equally dividing the end surface EF1 of the Z-X cross section illustrated in FIG. 3 in the Z-axis direction, measuring the lengths of the first regions 4 intersecting the straight lines, and averaging the lengths.

A thickness t[5] of the second region is 5 μm or more and 70 μm or less. Here, the thickness t[5] is a dimension along the X-axis direction from the boundary between the second region 5 and the first region 4 to the boundary between the second region 5 and the first plating layer 6. The thickness t[5] in the present embodiment may be obtained by, for example, drawing ten straight lines in the X-axis direction at ten positions obtained by equally dividing the end surface EF1 of the Z-X cross section illustrated in FIG. 3 in the Z-axis direction, measuring the lengths of the second regions 5 intersecting with the straight lines, and averaging the lengths.

The first region 4 and the second region 5 are both composed mainly of Cu, but may be composed of a metal selected from, for example, Fe (iron), Zn (zinc), Al (aluminum), Sn (tin), Ni (nickel), Ti (titanium), Ag (silver), Au (gold), Pt (platinum), Pd (palladium), Ta (tantalum), and W (tungsten), or may be composed of an alloy containing these metals. The material of the main component of the first region 4 may be Ni, and the material of the main component of the second region 5 may be Cu. By making the crystal grain size of Ni smaller than the crystal grain size of Cu and using Ni in the first region 4, it is possible to effectively prevent moisture from entering the ceramic element.

The first region 4 and the second region 5 may have a structure containing an alloy of Ni and Cu.

The first plating layer 6 is a Ni plating layer. The second plating layer 7 is a Sn plating layer. Instead of these two plating layers, three plating layers may be provided. When the three plating layers are formed, the materials thereof may be a Cu plating layer, a Ni plating layer, and a Sn plating layer in this order from the ceramic element 2. Alternatively, Au (gold) may be used as a plating material.

With this configuration, in the multilayer ceramic capacitor 1, when a voltage is applied between the first external electrode 3A and the second external electrode 3B, the voltage is applied to the plurality of dielectric layers 27 between the first internal electrode 25 and the second internal electrode 26 in the opposing region. Thus, in the multilayer ceramic capacitor 1, electric charges corresponding to the voltage between the first external electrode 3A and the second external electrode 3B are stored.

In the first external electrode 3A and the second external electrode 3B, both the cross section parallel to the X-Z plane and the cross section parallel to the X-Y plane have a U shape. That is, each of the first external electrode 3A and the second external electrode 3B covers the end surface and extends on the main surface and side surface continuous with the end surface. The shapes of the first external electrode 3A and the second external electrode 3B are not limited to the examples illustrated in the drawings.

The size of the multilayer ceramic capacitor 1 is not particularly limited, but for example, as designed values, any one of the sizes of 0.25 mm long, 0.125 mm wide, and 0.125 mm high (0201 size), 0.4 mm long, 0.2 mm wide, and 0.2 mm high (0402 size), 0.6 mm long, 0.3 mm wide, and 0.3 mm high (0603 size), 1.0 mm wide, 0.5 mm wide, and 0.5 mm high (1005 size), 3.2 mm wide, 1.6 mm wide, and 1.6 mm high (3216 size), 4.5 mm wide, 3.2 mm wide, and 2.5 mm high (4532 size), and 5.7 mm wide, 5.0 mm wide, and 2.3 mm high (5750 size) can be selected. The size of the multilayer ceramic capacitor 1 may be smaller than 0402 size, that is, any one of the length, width, and height of the multilayer ceramic capacitor 1 may be smaller than 0402 size. Each above size may include a dimensional tolerance of ±5 to ±30%.

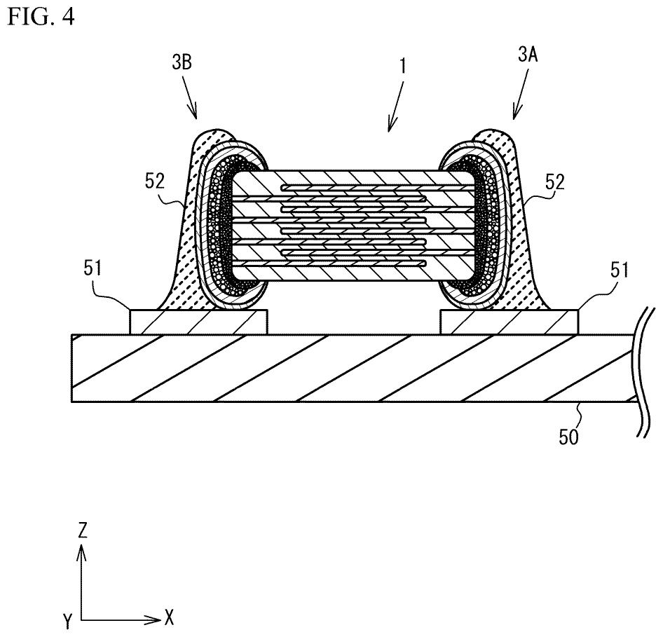

The multilayer ceramic capacitor 1 according to the present embodiment is used by being mounted on a substrate 50 as illustrated in FIG. 4, for example. The first external electrode 3A and the second external electrode 3B are disposed on and in contact with lands 51 provided on the substrate 50, and are fixed to the lands 51 by solder fillets 52. The multilayer ceramic capacitor 1 is subjected to stress due to thermal contraction from the solder fillet 52, stress due to deflection caused by external force applied to the substrate 50, and repeated stress due to heat cycles caused by heat generation of surrounding electronic elements. However, in the multilayer ceramic capacitor 1 according to the present embodiment, the second region 5 having a larger average crystal grain size than that of the first region 4 is provided outside the first region 4, that is, on the side opposite to the ceramic element 2, in the base layer of the external electrode. Such a structure of the external electrode can effectively reduce the stress applied from the solder portion to the external electrode after solder mounting, and thus can improve the crack resistance of the multilayer ceramic capacitor 1 after solder mounting.

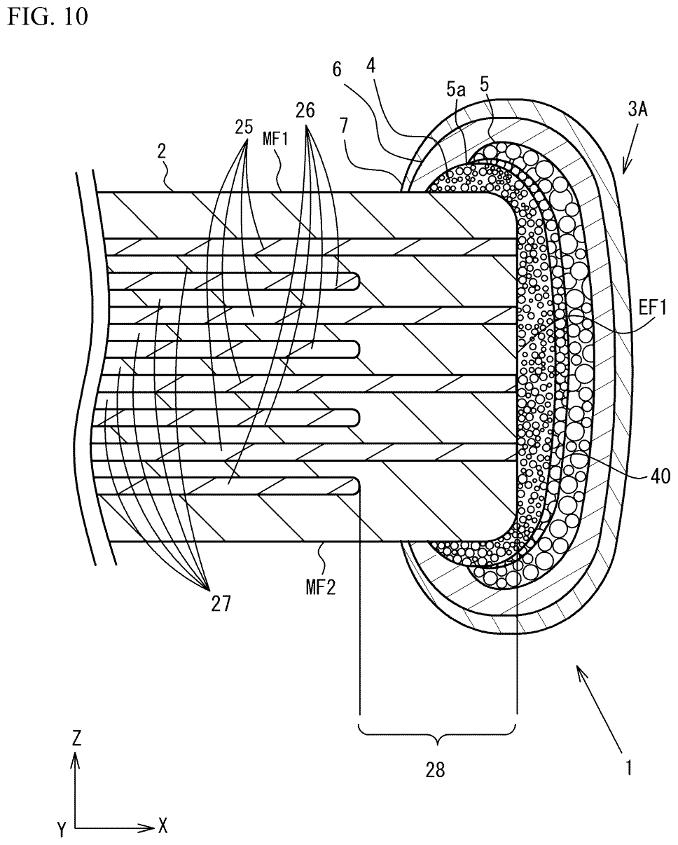

Note that a third region 40 in which the crystal grain size gradually increases from the first region toward the second region without the boundary between the first region 4 and the second region 5 being clear as illustrated in FIG. 3 may be generated (referring to FIG. 10). The average crystal grain size of the third region 40 is between the average crystal grain size of the first region 4 and the average crystal grain size of the second region 5. This is caused by the fact that when the sintering time of the external electrode is increased or the sintering temperature is increased, the growth of the crystal grains is further advanced, and thus a region of crystal grains having a size intermediate between the two sizes is generated. The presence of the third region 40 can prevent the first region 4 and the second region 5 from being delaminated from each other. The method for measuring the average crystal grain size of the third region 40 is the same as the method for measuring the average crystal grain size of the first region 4 and the second region 5.

When the third region 40 is generated, the thickness of each of the first region 4 and the second region 5 may be measured by specifying the boundary position between the first region 4 and the second region 5 as the center position of the third region 40. When the crystal grain sizes of the first region 4 and the second region 5 are measured, the measurement may be performed by extracting the crystal grains from regions clearly distinguished as the first region 4 and the second region 5 without extracting the crystal grains from the third region 40.

### [Manufacturing Method]

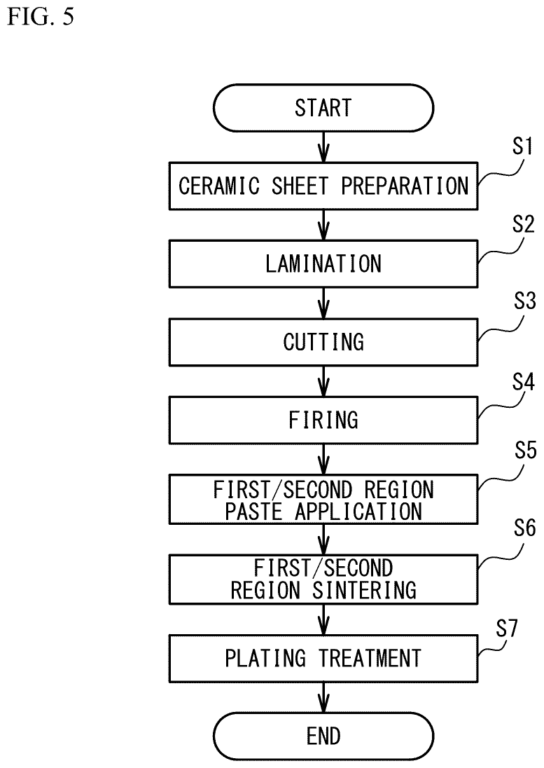

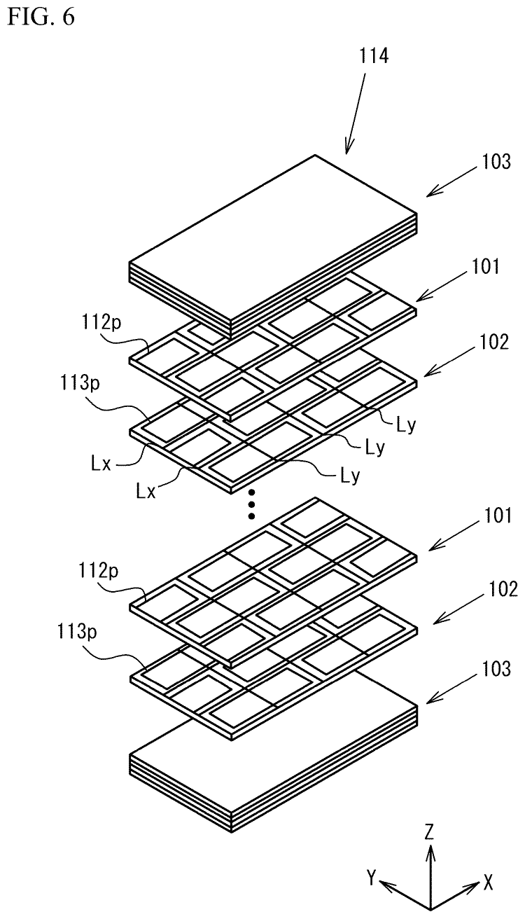

Next, an example of a method of manufacturing the multilayer ceramic capacitor 1 will be described with reference to FIGS. 5 to 8B. FIG. 5 is a flowchart illustrating an example of a method of manufacturing the multilayer ceramic capacitor 1 according to the embodiment. FIGS. 6A to 8B are perspective views illustrating a part of a step included in the method of manufacturing the multilayer ceramic capacitor 1.

### (Ceramic Sheet Preparation: Step S1)

In step S1, first ceramic sheets 101 and second ceramic sheets 102 are prepared. The first ceramic sheet 101 and the second ceramic sheet 102 respectively have first internal electrode patterns 112p and second internal electrode patterns 113p formed by printing a Ni paste on a dielectric ceramic for forming the dielectric layer 27, for example a dielectric green sheet containing BaTiO₃ as a main component. In addition, third ceramic sheets 103, which are similar green sheets, are prepared. The first internal electrode pattern 112p and the second internal electrode pattern 113p can be formed by applying any conductive paste to the ceramic sheets 101 and 102 by a printing method or the like. No internal electrode pattern is provided on the third ceramic sheet 103.

### (Lamination: Step S2)

Next, the ceramic sheets 101, 102, and 103 are laminated to form a laminated sheet 114. At this stage, the laminated sheet 114 is configured as a large sheet that is not singulated. FIG. 6 illustrates cutting lines Lx and Ly for singulating the multilayer ceramic capacitors 1. The cutting line Lx is parallel to the X axis, and the cutting line Ly is parallel to the Y axis.

The first internal electrode patterns 112p corresponding to first internal electrodes 25 are provided on the first ceramic sheet 101. The second internal electrode patterns 113p corresponding to second internal electrodes 26 are formed on the second ceramic sheet 102. The first internal electrode pattern 112p and the second internal electrode pattern 113p are cut along the cutting lines Lx and Ly to form the first internal electrodes 25 and the second internal electrodes 26 of the multilayer ceramic capacitors 1.

The first internal electrode pattern 112p is configured in a substantially rectangular shape extending in the X-axis direction across the cutting line Ly. The first internal electrode patterns 112p are arranged with the cutting lines Lx and Ly interposed therebetween. In the first ceramic sheet 101, a region along the cutting line Lx where the first internal electrode pattern 112p is not formed forms the side margin 22. In the first ceramic sheet 101, a region along the cutting line Ly where the first internal electrode pattern 112p is not formed forms the end margin 28.

The second internal electrode pattern 113p is configured in the same manner as the first internal electrode pattern 112p. However, the second internal electrode pattern 113p is formed so as to be shifted from the first internal electrode pattern 112p by one chip in the X-axis direction or the Y-axis direction. In the second ceramic sheet 102, the side margin 22 is formed in a region along the cutting line Lx where the second internal electrode pattern 113p is not formed. In the second ceramic sheet 102, the end margin 28 is formed in a region along the cutting line Ly in which the second internal electrode pattern 113p is not formed.

As illustrated in FIG. 6, in the laminated sheet 114, a multilayer body of the third ceramic sheets 103 is disposed on the upper and lower surfaces in the Z-axis direction of a multilayer body in which the first ceramic sheets 101 and the second ceramic sheets 102 are alternately laminated in the Z-axis direction. The number of the ceramic sheets 101, 102, and 103 and the thickness thereof can be adjusted as appropriate.

In the laminated sheet 114, portions in which regions where the first internal electrode patterns 112p and the second internal electrode patterns 113p are not formed are laminated correspond to margin portions. On the other hand, in the laminated sheet 114, portions where both the first internal electrode patterns 112p and the second internal electrode patterns 113p are laminated correspond to capacitance forming portions.

The laminated sheet 114 is compressed in the Z-axis direction and is pressure-bonded. As a compression method, a conventionally known method, for example, a uniaxial pressing method or a hydrostatic pressing method can be adopted.

### (Cutting: Step S3)

In the step S3, the laminated sheet 114 obtained in the step S2 is cut along the cutting lines Lx and Ly. Thus, an unfired ceramic element 111u is manufactured.

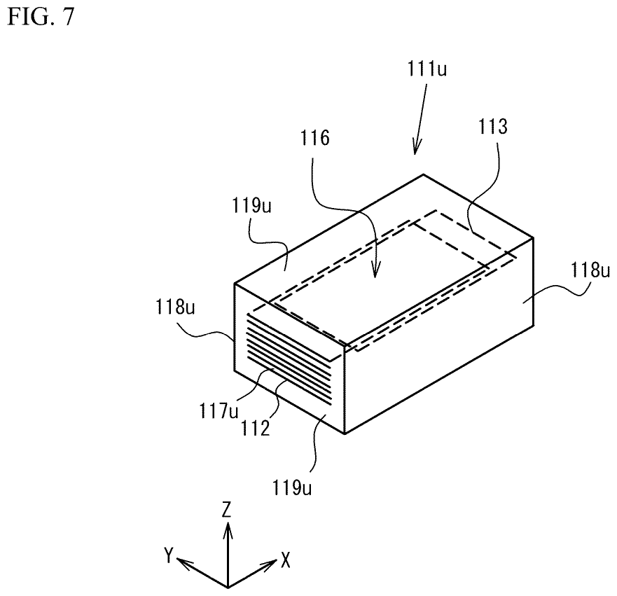

FIG. 7 is a schematic perspective view of the ceramic element 111u obtained in step S3. As illustrated in these drawings, the ceramic element 111u includes a capacitance forming portion 116 in which internal electrodes 112 and 113 are laminated, margin portions (end margin portions 117u and side margin portions 118u) around the capacitance forming portion 116, and cover portions 119u located outside the capacitance forming portion 116 in the Z-axis direction.

### (Firing: Step S4)

In the step S4, the unfired ceramic element 111u obtained in the step S3 is fired to manufacture the ceramic element 2 of the multilayer ceramic capacitor 1. The sintering temperature in the step S4 portion can be determined based on the sintering temperature of the ceramic element 2 using a conventionally known method. The firing can be performed, for example, in a reducing atmosphere or in an atmosphere with a low oxygen partial pressure. For example, the firing may be performed in a reducing atmosphere at 1100 to 1200 degrees Celsius for 0.5 to 2.0 hours, and then the firing may be further performed in an atmosphere containing oxygen at 1000 degrees Celsius for 0.5 hours.

### (Application of First Paste and Second Paste: Step S5)

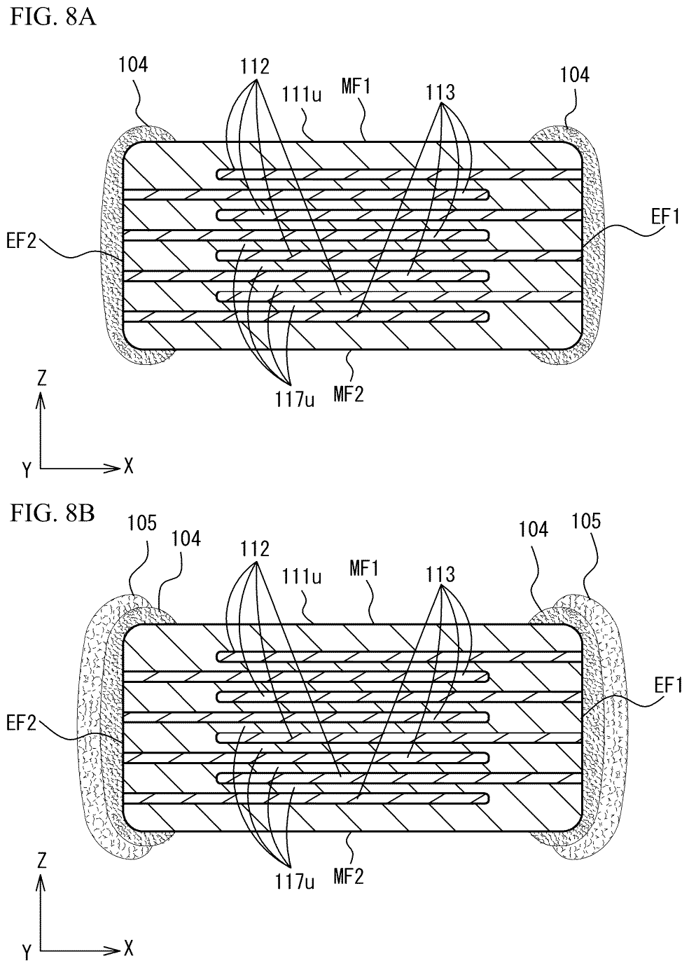

As illustrated in FIGS. 8A and 8B, in the step S5, a first paste 104 for forming the first region 4 is applied to the ceramic element 2 obtained in the step S4. Then, a second paste 105 for forming the second region 5 is applied so as to overlap the first paste 104. Here, the first paste 104 is a Cu paste having an average crystal grain size of, for example, 0.4 μm or more and 0.6 μm or less. The second paste 105 is a Cu paste having an average crystal grain size of, for example, 0.8 μm or more and 1.2 μm or less. As a method of applying the first paste 104 and the second paste 105, a conventionally known method can be adopted as appropriate, and for example, a dipping method or the like can be adopted.

### (First Region and Second Region Sintering: Step S6)

In the step S6, the first paste 104 and the second paste 105 applied in the step S5 are sintered. The sintering is performed by keeping the ceramic element 2 to which the first paste 104 and the second paste 105 are applied, for example, in a nitrogen atmosphere in an environment of 650 to 800 degrees Celsius for 0.5 to 1.0 hours. When the average crystal grain size of the paste is large, the time until the sintering is completed is long. Therefore, the second paste 105 requires a longer time for sintering than the first paste 104. Therefore, the time required for completing the sintering can be shortened by adding, for example, a glass component to the second paste 105. Note that when the materials of the base layers are different, the first sintering may be performed after the first paste 104 is applied, and the second sintering may be performed after the second paste 105 is applied.

### (Plating Treatment: Step S7)

In the step S7, the first plating layer 6 is formed so as to cover the first region 4 and the second region 5 formed in the step S6. Then, the second plating layer 7 is formed so as to cover the first plating layer 6. The material of the first plating layer 6 may be, for example, Ni, and the material of the second plating layer 7 may be, for example, Sn. For these plating treatments, a conventionally known method can be adopted. Therefore, the detailed description thereof is omitted here.

The multilayer ceramic capacitor 1 according to the present embodiment includes, as the external electrode, the first region 4 and the second region 5 of the base layer in this order from the ceramic element 2, and the average crystal grain size of the material forming the first region 4 is smaller than the average crystal grain size of the material forming the second region 5. This improves the moisture resistance of the multilayer ceramic capacitor 1 and the crack resistance of the multilayer ceramic capacitor 1 after solder mounting.

### (Variations)

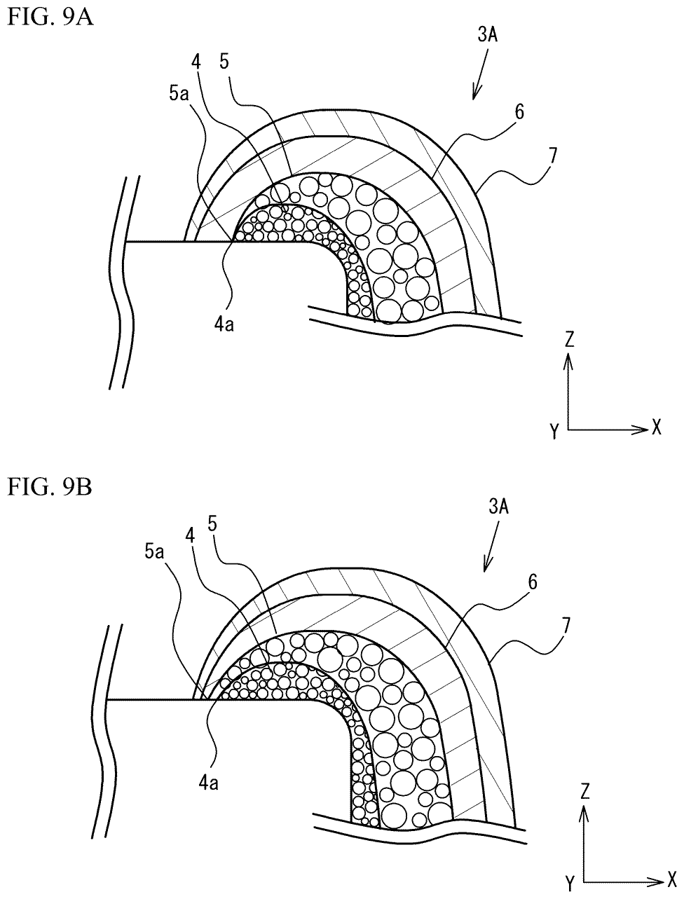

Next, variations of the multilayer ceramic capacitor will be described with reference to FIGS. 9A and 9B. In the multilayer ceramic capacitor 1 of the first embodiment, the end portion 5a of the second region 5 in the first main surface MF1 and the second main surface MF2 and the first side surface SF1 and the second side surface SF2 is located on the first region 4. In contrast, in the variation illustrated in FIG. 9A, the end portion 5a of the second region 5 coincides with an end portion 4a of the first region 4. In still another variation illustrated in FIG. 9B, the end portion 5a of the second region 5 is located close to the center of the ceramic element 2 in the X-axis direction, with compared to the end portion 4a of the first region 4. As described above, the positional relationship between the end portions of the first region 4 and the second region 5 can be changed in various ways.

### Examples

Next, examples will be described in comparison with comparative examples. In the example, samples were prepared in which the outer dimensions L[1]×W[1]×H[1] of the multilayer ceramic capacitor 1 according to the embodiment were set to 3.2×2.5×2.5 mm and the combination of a thickness t[4] of the first region 4 and a thickness t[5] of the second region 5 was different, and were subjected to a heat cycle test. In addition, the occurrence of contact failure between the internal electrode and the external electrode was examined. The number of samples is 1000 for each.

The sum of the thickness t[4] of the first region 4 and the thickness t[5] of the second region 5 was set in a range of 35 to 75 μm. For example, when the thickness t[4] of the first region 4 is 5 μm and the thickness t[5] of the second region 5 is 30 μm, the sum of the thickness t[4] of the first region 4 and the thickness t[5] of the second region 5 is 35 μm. For example, when the thickness t[4] of the first region 4 is 10 μm and the thickness t[5] of the second region 5 is 60 μm, the sum of the thickness t[4] of the first region 4 and the thickness t[5] of the second region 5 is 70 μm. The values of the thickness t[4] of the first region 4 and the thickness t[5] of the second region 5 are not required to be strictly determined, and the sum of the thickness t[4] of the first region 4 and the thickness t[5] of the second region 5 may be set in a range of 5 to 75 μm.

The heat cycle test was conducted with each sample mounted on the substrate 50 as illustrated in FIG. 4, starting at 25 degrees Celsius, followed by 150 degrees Celsius for 30 minutes, then 25 degrees Celsius for 15 minutes, then −40 degrees Celsius for 30 minutes, and finally 25 degrees Celsius for 15 minutes. This cycle was repeated 100 times. Then, the presence or absence of cracks in each sample was observed, and the case where cracks were observed was evaluated as “X”.

As for the contact failure, when there was one or more samples in which the capacitance value measured after the heat cycle test was decreased by 5% or more from the design capacitance value, the contact failure was determined as “X”.

The value of the average crystal grain size of the base layer of the external electrode was obtained by observing the cross section of each sample with a scanning ion microscope, randomly extracting 20 crystal grains from each of the first region and the second region of the base layer from the entire region of each region, measuring the major axis and the minor axis of the crystal grains, and averaging the data of 40 crystal grains. The cross section of the sample is a cross section taken along line A-A in FIG. 1. At this time, the position of the line A-A in the Y-axis direction was set to be within the range of the central region when the width dimension W[1] is divided into three equal parts.

In Example 1, the average crystal grain size of the first region 4 was 0.9 μm, and the average crystal grain size of the second region 5 was 1.3 μm. In Example 2, the average crystal grain size of the first region 4 was 1.1 μm, and the average crystal grain size of the second region 5 was 1.3 μm. In Example 3, the average crystal grain size of the first region 4 was 1.1 μm, and the average crystal grain size of the second region 5 was 1.5 μm. In Example 4, the average crystal grain size of the first region 4 was 1.5 μm, and the average crystal grain size of the second region 5 was 1.9 μm.

In contrast, in each of Comparative Example 1, Comparative Example 2, and Comparative Example 3, a single base layer was provided instead of the first region 4 and the second region 5. The main component of the base layer was Cu. The average crystal grain size of the base layer in Comparative Example 1 was 0.9 μm. The average crystal grain size of the base layer in Comparative Example 2 was 1.3 μm. The average crystal grain size of the base layer in Comparative Example 3 was 1.9 μm.

As a result of performing the above-described heat cycle test on these examples and comparative examples, no cracks were observed and no contact failure occurred in any of Examples 1 to 4. In contrast, cracks occurred in all of Comparative Examples 1 to 3. In addition, although contact failure did not occur in Comparative Example 1 and Comparative Example 2,contact failure occurred in Comparative Example 3.

From the above results, it was confirmed that by making the average crystal grain size of the first region 4 smaller than the average crystal grain size of the second region 5, the occurrence of cracks due to the heat cycle test can be suppressed without causing contact failure between the internal electrode and the external electrode. It is presumed that, by increasing the average crystal grain size of the second region 5 to which the thermal stress due to the heat cycle is directly applied, plastic deformation is more likely to occur than when the crystal grain size is small, and the stress is relaxed. It is also presumed that an interface is formed between the first region 4 and the second region 5, and this interface relaxes the stress.

TABLE 1

| | EXTERNAL | EXTERNAL | | |
|---|---|---|---|---|
| | ELEC- | ELEC- | | |
| | TRODE-1ST | TRODE-2ND | | CONTACT |
| | REGION- | REGION- | HEAT | FAILURE |
| | AVERAGE | AVERAGE | CYCLE | WITH |
| | CRYSTAL | CRYSTAL | TEST | INTERNAL |
| | GRAIN | GRAIN | RE- | ELEC- |
| | SIZE [μm] | SIZE [μm] | SULTS | TRODE |
| EXAMPLE 1 | 0.9 | 1.3 | ◯ | ◯ |
| EXAMPLE 2 | 1.1 | 1.3 | ◯ | ◯ |
| EXAMPLE 3 | 1.1 | 1.5 | ◯ | ◯ |
| EXAMPLE 4 | 1.5 | 1.9 | ◯ | ◯ |
| COMPERATIVE | 0.9 | | X | ◯ |
| EXAMPLE 1 | | | | |
| COMPERATIVE | 1.3 | | X | ◯ |
| EXAMPLE 2 | | | | |
| COMPERATIVE | 1.9 | | X | X |
| EXAMPLE 3 | | | | |

In each of the above-described embodiments, the multilayer ceramic capacitor has been described as an example of a multilayer ceramic electronic component, but the present embodiment is not limited thereto. For example, the configurations of the above-described embodiments are applicable to other multilayer ceramic electronic components such as varistors and thermistors.

The above embodiments are merely examples for carrying out the present disclosure, and the present disclosure is not limited to these embodiments. It is to be understood that the various change, substitutions, and alterations could be made hereto without departing from the spirit and scope of the invention.

What is claimed is:

1. A multilayer ceramic electronic component comprising:
a ceramic element having dielectric layers and internal electrodes alternately laminated in a first axis direction, a pair of main surfaces facing each other along the first axis direction, a pair of side surfaces facing each other in a second axis direction orthogonal to the first axis direction, and a pair of end surfaces facing each other in a third axis direction orthogonal to the first axis direction and the second axis direction; and
an external electrode provided at an end portion of the ceramic element in the third axis direction so as to be electrically connected to the internal electrode led out to a different end surface of the ceramic element in the third axis direction,
wherein
the external electrode includes a first region and a second region in this order from the ceramic element, and
an average crystal grain size of crystal grains forming the first region is smaller than an average crystal grain size of crystal grains forming the second region.

2. The multilayer ceramic electronic component according to claim 1, wherein
the external electrode includes the first region in contact with the ceramic element and the second region in contact with the first region.

3. The multilayer ceramic electronic component according to claim 1, wherein
the average crystal grain size of crystal grains forming the first region is 0.9 μm or more and 1.5 μm or less.

4. The multilayer ceramic electronic component according to claim 1, wherein
the average crystal grain size of crystal grains forming the second region is 1.3 μm or more and 1.9 μm or less.

5. The multilayer ceramic electronic component according to claim 1, wherein
a main component of the first region and the second region is Cu.

6. The multilayer ceramic electronic component according to claim 1, wherein
the first region contains Ni as a main component and the second region contains Cu as a main component.

7. The multilayer ceramic electronic component according to claim 1, wherein
the first region has a thickness of 5 μm or more and 70 μm or less.

8. The multilayer ceramic electronic component according to claim 1, wherein
the second region has a thickness of 5 μm or more and 70 μm or less.

9. The multilayer ceramic electronic component according to claim 1, further comprising
a plating layer provided outside the second region.

10. The multilayer ceramic electronic component according to claim 1, wherein
a base layer of the external electrode includes a third region between the first region and the second region, and an average crystal grain size of crystal grains forming the third region is between the average crystal grain size of crystal grains forming the first region and the average crystal grain size of crystal grains forming the second region.

11. A method of manufacturing a multilayer ceramic electronic component, comprising:
laminating ceramic sheets on which internal electrode patterns forming internal electrodes are formed in a first axis direction and pressure-bonding the ceramic sheets to obtain a multilayer sheet;
cutting and firing the multilayer sheet to obtain a ceramic element in which dielectric layers and internal electrodes are alternately laminated along the first axis direction, the ceramic element having a pair of main surfaces facing each other along the first axis direction, a pair of side surfaces facing each other in a second axis direction orthogonal to the first axis direction, and a pair of end surfaces facing each other in a third axis direction orthogonal to the first axis direction and the second axis direction;
disposing a first conductor paste for forming a first region having conductivity in a region including the end surfaces at both end portions of the ceramic element in the third axis direction;
disposing a second conductive paste having an average crystal grain size larger than an average crystal grain size of the first conductive paste so as to overlap the first conductive paste, the second conductive paste being for forming a second region overlapping the first region; and
sintering the first conductor paste and the second conductor paste.
